(19) United States
(12) Patent Application Publication
(10) Pub. No.: US 2026/0058044 A1
(43) Pub. Date: Feb. 26, 2026

(54) CONNECTING DEVICE AND GIMBAL

(71) Applicant: Shenzhen Yuanli Chuangzhi Technology Co., LTD, Shenzhen (CN)

(72) Inventor: Hailong Li, Shenzhen (CN)

(21) Appl. No.: 18/939,913

(22) Filed: Nov. 7, 2024

(30) Foreign Application Priority Data
Aug. 23, 2024 (CN) 202422081583.7
Sep. 27, 2024 (CN) 202422381032.2

(51) Int. Cl. H01F 7/02

(52) U.S. Cl. CPC H01F 7/0252

(57) ABSTRACT

The disclosure relates to a connecting device and a gimbal. A box is provided with a first accommodating slot, a housing is provided with a connecting structure such that two opposite sides of the housing are both connectable to a gimbal body through the connecting structure, and two opposite sides of the lid are further provided with second dodging slots. A clamping region of clamping arms and a magnetic attraction region of a first magnetic attraction assembly are respectively arranged on the two opposite sides of the housing. The disclosure solves the problem that the connecting device in the prior art only has one connecting and fixing method, which leads to smaller applicability and inconvenience to use.

### CROSS REFERENCE TO RELATED APPLICATIONS

The present application claims the benefit of Chinese Patent Application Nos. 202422081583.7 filed on Aug. 23, 2024 and 202422381032.2 filed on Sep. 27, 2024. All the above are hereby incorporated by reference in their entirety.

### FIELD OF TECHNOLOGY

The disclosure relates to the technical field of gimbals, and in particular to a connecting device and a gimbal.

### BACKGROUND

With the popularization of electronic apparatuses, people generally need a holder that can support or carry electronic apparatuses. Therefore, gimbals that make people use electronic apparatuses more conveniently and flexibly are designed according to ergonomics.

In order to meet users'growing demands for functionality in the use of gimbals, functions of gimbal apparatuses are also improving and upgrading accordingly. A conventional gimbal includes an actuating arm capable of switching its direction and angle, and a connecting device arranged on the actuating arm and configured to clamp an electronic apparatus. At present, the connecting device arranged on the gimbal typically fixes the electronic apparatus by means of clamping with a clamping jaw or magnetic attraction. Usually, such a gimbal can only function as a clamp, and cannot be disassembled or switched, which affects the applicability of the gimbal and makes the gimbal inconvenient to use.

### SUMMARY

The technical problem to be solved by examples of the disclosure is to provide a connecting device and a gimbal, in order to solve the problem that the connecting device in the prior art only has one connecting and fixing method, which leads to smaller applicability and inconvenience to use.

In a first aspect, the disclosure discloses a connecting device, including: a housing, a first magnetic attraction assembly and two clamping assemblies. The housing includes a box and a lid that are buckled with each other. The box is provided with a first accommodating slot, the housing is provided with a connecting structure such that two opposite sides of the housing are both connectable to a gimbal body through the connecting structure, and two opposite sides of the lid are further provided with second dodging slots. The first magnetic attraction assembly is arranged in the first accommodating slot. Each of the clamping assemblies includes a clamping arm, the two clamping assemblies are respectively arranged on the two opposite sides of the housing, one end of each of the clamping assemblies runs through the second dodging slot to expose the clamping arm, the clamping assemblies are slidably connected to the housing, the clamping arms are configured to clamp an electronic apparatus, and a clamping region of the clamping arms and a magnetic attraction region of the first magnetic attraction assembly are respectively arranged on the two opposite sides of the housing.

Optionally, the connecting structure includes positioning slots provided on the two opposite sides of the lid, the box is provided with a first dodging slot corresponding to one of the positioning slots, and the first dodging slot is configured to expose the positioning slot such that the connecting structure is fastened with a fastening portion of the gimbal body through the positioning slot.

Optionally, the connecting structure includes a connecting hole running through the housing, and a rotary ring arranged in the connecting hole, an inner wall of the connecting hole is provided with a sliding rail, an outer ring of the rotary ring is provided with a sliding slot corresponding to the sliding rail, the rotary ring is rotatably connected to the connecting hole through the sliding rail and the sliding slot, an inner ring of the rotary ring is provided with a threaded hole, and two opposite sides of the rotary ring are respectively provided with bumps such that the connecting structure is threadedly connected to a threaded rod of the gimbal body through the rotary ring.

Optionally, the connecting structure includes a through slot running through the housing, and inner walls on two opposite sides of the through slot are respectively provided with a limit slot such that the connecting structure is fastened with a fastening portion of the gimbal body through the limit slots.

Optionally, the connecting structure includes boot openings respectively provided on the two opposite sides of the housing, each of the boot openings includes a connecting slot and a snap-fit slot in communication with each other, two opposite sides of the snap-fit slot are provided with limit plates, and the limit plates are arranged at a top of the snap-fit slot such that the connecting structure is fastened with a fastening portion of the gimbal body through the limit plates.

Optionally, each of the clamping assemblies further includes an elastic retractable module, the elastic retractable module runs through the second dodging slot and is rotatably connected to the clamping arm, the clamping arm is rotatable by a preset angle relative to the elastic retractable module such that the clamping arm has a first state of being folded and a second state of being unfolded relative to the elastic retractable module, and the clamping arm in the second state extends toward a side away from the first magnetic attraction assembly.

Optionally, the elastic retractable module includes connecting rods, first elastic members and a connecting block, a side of the box facing the lid and a side of the lid facing the box are respectively connected with a connecting member, the connecting member is provided with a via hole, the connecting rod is slidably connected to the via hole, the connecting rod runs through the second dodging slot and is connected to the connecting block, the clamping arm is rotatably connected to the connecting block, an end of the connecting rod away from the connecting block is provided with a limit cap, one end of the first elastic member abuts against the limit cap, and the other end abuts against an edge of the via hole.

Optionally, the connecting device further includes conductive seats, the conductive seats are arranged on the box and the lid respectively, the box and the lid are respectively provided with a first dodging hole, the conductive seats are exposed through the first dodging holes, and the conductive seats are configured to be electrically connected to the gimbal body; and the connecting device further includes an external module, the external module is arranged on a side of the connecting block away from the connecting rod, the conductive seats are electrically connected to the connecting members and/or the connecting rods through connecting lines, the connecting block is provided with conductive sockets, the external module is provided with conductive posts arranged corresponding to the conductive sockets, and the conductive posts are electrically connected to the conductive sockets.

Optionally, the connecting device further includes a plurality of trigger keys and second elastic members, the trigger keys are slidably connected to the box or the lid, one end of each of the trigger keys is provided with an abutting post, the abutting post is exposed after running through the second dodging hole respectively provided in the box or the lid, the second elastic member is arranged between the trigger key and the lid or the box, each of the trigger keys further includes an abutting block, the abutting block is arranged in an opposite direction to the abutting post, the box and the lid are respectively provided with a third dodging hole corresponding to the abutting block, the abutting block is exposed through the third dodging holes, and the abutting post is configured to abut against the electronic apparatus.

Optionally, the first magnetic attraction assembly includes a protecting pad, an iron sheet and one or a plurality of magnetic attraction members arranged between the protecting pad and the iron sheet, the iron sheet is closely attached to a bottom of the first accommodating slot, the protecting pad is exposed through the first accommodating slot, when there is one magnetic attraction member, the magnetic attraction member is in a shape of a circular ring or a square, and when there are a plurality of magnetic attraction members, the magnetic attraction members are respectively in a shape of an arc or a square.

Optionally, the connecting device further includes a second magnetic attraction assembly, the box further extends to form an extension portion, the extension portion is provided with a second accommodating slot, the second magnetic attraction assembly is arranged in the second accommodating slot, the second accommodating slot is provided in a same direction as the first accommodating slot, and the second accommodating slot is provided on a side of a circumference of the first accommodating slot.

In a second aspect, the disclosure further discloses a gimbal. The gimbal includes a grip, a gimbal body and a connecting device. The gimbal body is rotatably connected to the connecting device; and the gimbal body includes a connecting arm and a rotating module that are rotatably connected, a rotating motor is arranged between the connecting arm and the rotating module, the rotating module is rotatably connected to the connecting arm through the rotating motor, and the connecting device is connected to a side of the rotating module away from the connecting arm.

Optionally, the connecting device includes: a housing, a first magnetic attraction assembly and two clamping assemblies. The housing includes a box and a lid that are buckled with each other, the box is provided with a first accommodating slot, two opposite sides of the housing are respectively provided with a connecting structure, the connecting structure is configured to be connected to the gimbal body, and two opposite sides of the lid are further provided with second dodging slots. The first magnetic attraction assembly is arranged in the first accommodating slot. Each of the clamping assemblies includes a clamping arm, the two clamping assemblies are respectively arranged on the two opposite sides of the housing, one end of each of the clamping assemblies runs through the second dodging slot to expose the clamping arm, the clamping assemblies are slidably connected to the housing, the clamping arms are configured to clamp an electronic apparatus, and a clamping region of the clamping arms and a magnetic attraction region of the first magnetic attraction assembly are respectively arranged on the two opposite sides of the housing.

Optionally, a side of the rotating module facing the connecting device is further provided with a locking assembly, the locking assembly includes a fixed seat, a third elastic member and two locking buckles, two opposite sides of the fixed seat are provided with second sliding slots, the locking buckle is slidably connected to the second sliding slot, each of the locking buckles includes a locking portion and a manual adjusting portion, the third elastic member is arranged between the two locking portions, two opposite sides of the rotating module are provided with fourth dodging slots, the manual adjusting portion is exposed after running through the fourth dodging slot, two opposite sides of an inner wall of a positioning slot of the connecting device are respectively provided with a locking slot, the fixed seat is correspondingly connected to the positioning slot, and the locking portion is capable of being locked to or unlocked from the locking slot.

Optionally, elastic contact pins and an electric switch are arranged in the rotating module, the elastic contact pins and the electric switch are respectively exposed after running through the rotating module, the elastic contact pins are correspondingly connected to conductive seats of the connecting device, and the electric switch correspondingly abuts against an abutting block of the connecting device.

Optionally, the box and the lid of the connecting device are respectively provided with a foolproof position, a side of the rotating module facing the connecting device is provided with positioning protrusions, and the positioning protrusions are correspondingly connected to the foolproof positions.

Optionally, the connecting arm is a single steering knuckle or a plurality of steering knuckles connected sequentially.

In a third aspect, the disclosure further discloses a gimbal. The gimbal includes a grip, a gimbal body and the connecting device. The gimbal body is rotatably connected to the connecting device.

Compared with the prior art, the connecting device according to the examples of the disclosure has the following beneficial effects: The housing includes the box and the lid, the side of the box away from the lid is provided with the first accommodating slot, and the first magnetic attraction assembly is accommodated in the first accommodating slot, thereby realizing the magnetic attraction function of the connecting device. The clamping assemblies arranged on the two opposite sides of the housing include the clamping arms such that the clamping assemblies can clamp the electronic apparatus placed on the connecting device through the clamping arms. Thus, the connecting device can be connected to the electronic apparatus by two different methods, thereby improving the flexibility and applicability of the connecting device. With the two connecting methods based on the first magnetic attraction assembly and the clamping assemblies, the electronic apparatus on the connecting device can be fixed firmly, thereby preventing the electronic apparatus on the connecting device from shaking or falling off during use, and protecting the safety of the electronic apparatus. During actual use, the clamping assemblies are slidable relative to the housing, so the clamping arms can clamp the electronic apparatus on the connecting device by stretching the clamping assemblies. The magnetic attraction member is arranged in the first accommodating slot on the side of the box away from the lid, and the clamping arms are arranged on the side of the connecting block facing the lid, so the connecting device can be connected to the electronic apparatus by different connecting methods by adjusting the direction during use. In addition, by arranging the connecting structure on the housing, the two opposite sides of the housing are both connectable to the gimbal body through the connecting structure, so when one side of the connecting device is connected to the electronic apparatus, the other side of the connecting structure away from the electronic apparatus can be connected to the gimbal body. With the above arrangement, the connecting device is more convenient and flexible to operate, and the user can conveniently select and adjust the clamping method of the connecting device to meet the demands for different scenarios and uses.

### BRIEF DESCRIPTION OF THE DRAWINGS

The technical solutions of the disclosure will be further described in detail below in conjunction with the accompanying drawings and examples, in which:

FIG. 1 is a schematic view of a connecting device according to an example of the disclosure;

FIG. 2 is a schematic view of a box and a first magnetic attraction assembly according to an example of the disclosure;

FIG. 3 is a schematic exploded view of the connecting device according to an example of the disclosure;

FIG. 4 is a schematic view of connecting lines and connecting members connected according to an example of the disclosure;

FIG. 5 is a schematic view of a lid and a trigger key according to an example of the disclosure;

FIG. 6 is a schematic view of the lid according to an example of the disclosure;

FIG. 7 is a schematic view of the trigger key according to an example of the disclosure;

FIG. 8 is a schematic view of a gimbal according to an example of the disclosure;

FIG. 9 is a schematic view of a gimbal body according to an example of the disclosure;

FIG. 10 is a schematic exploded view of the gimbal body according to an example of the disclosure;

FIG. 11 is a schematic view of a locking buckle according to an example of the disclosure;

FIG. 12 is a schematic view of clamping assemblies and a box according to an example of the disclosure;

FIG. 13 is a schematic view of clamping arms and protective pads according to an example of the disclosure;

FIG. 14 is a schematic view of a box and a second magnetic attraction assembly according to an example of the disclosure;

FIG. 15 is a schematic view of an external module and a connecting block according to an example of the disclosure;

FIG. 16 is a schematic view I of a connecting structure according to an example of the disclosure;

FIG. 17 is a schematic view II of a connecting structure according to an example of the disclosure; and

FIG. 18 is a schematic view III of a connecting structure according to an example of the disclosure.

Reference signs in the figures:
1000, connecting device; 100, housing; 110, connecting structure; 111, connecting hole; 1111, sliding rail; 112, rotary ring; 1121, sliding slot; 1122, threaded hole; 1123, bump; 113, through slot; 1131, limit slot; 114, boot opening; 1141, connecting slot; 1142, snap-fit slot; 1143, limit plate; 101, box; 1011, first accommodating slot; 1012, first dodging slot; 1014, first dodging hole; 1015, connecting member; 10151, via hole; 1016, first sliding slot; 1017, positioning post; 1018, third dodging hole; 1019, foolproof position; 102, lid; 1021, positioning slot; 10211, locking slot; 1022, extension portion; 10221, second accommodating slot; 1023, second dodging slot; 1024, third dodging slot; 1025, second dodging hole; 200, first magnetic attraction assembly; 201, protecting pad; 202, magnetic attraction member; 203, iron sheet; 300, clamping assembly; 301, elastic retractable module; 3011, connecting block; 30111, conductive socket; 3012, first elastic member; 3013, connecting rod; 30131, limit cap; 302, clamping arm; 3021, recess; 3022, protective pad; 400, conductive seat; 401, connecting line; 500, trigger key; 501, abutting post; 5021, snap-fit protrusion; 5022, extension rod; 5023, abutting block; 503, second elastic member; 2000, gimbal; 2001, grip; 600, gimbal body; 601, connecting arm; 6011, rotor; 602, rotating module; 6021, stator; 6022, positioning protrusion; 6023, locking assembly; 60231, fixed seat; 60232, third elastic member; 60233, second sliding slot; 603, fourth dodging slot; 604, rotating motor; 605, elastic contact pin; 606, electric switch; 607, locking buckle; 6071, locking portion; 6072, manual adjusting portion; 700, second magnetic attraction assembly; 800, external module; 801, conductive post.

### DESCRIPTION OF THE EMBODIMENTS

It should be noted that the examples in this application and the features in the examples may be combined with each other in the case of no conflict. Preferred examples of the disclosure will be described in detail below with reference to the accompanying drawings.

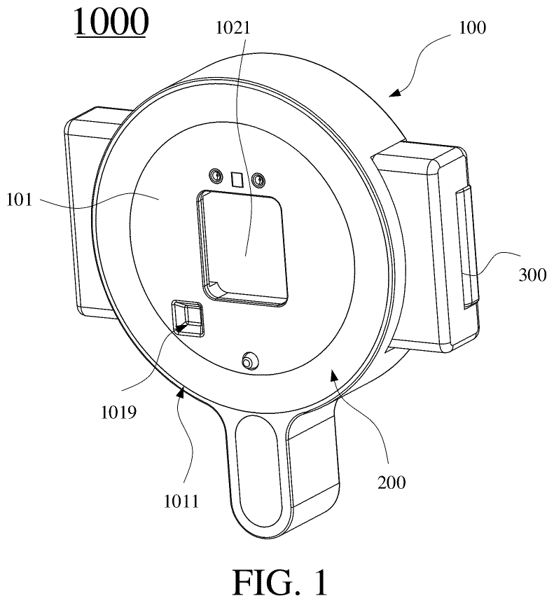

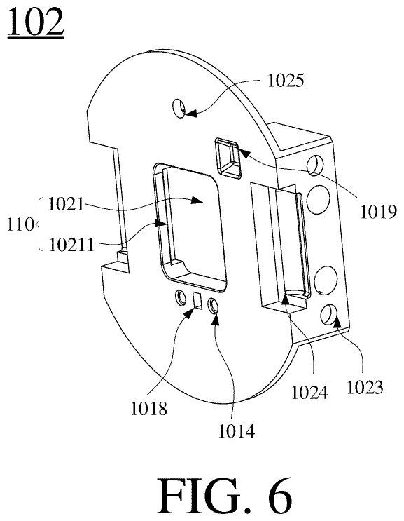

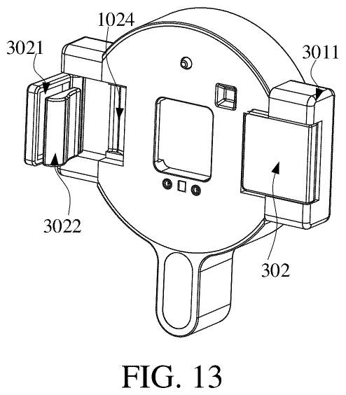

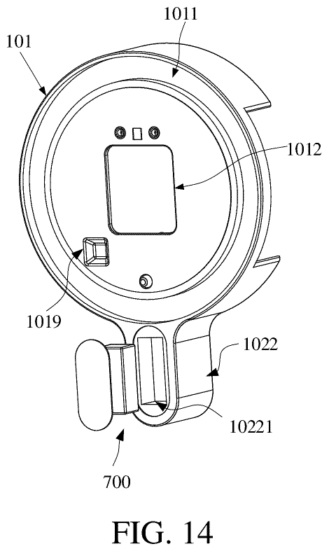

An example of the disclosure provides a connecting device 1000, as shown in FIG. 1, FIG. 6, FIG. 13 and FIG. 14, the connecting device 1000 includes: a housing 100, a first magnetic attraction assembly 200 and two clamping assemblies 300. The housing 100 includes a box 101 and a lid 102 that are buckled with each other. The box 101 is provided with a first accommodating slot 1011, the housing 100 is provided with a connecting structure 110 such that two opposite sides of the housing 100 are both connectable to a gimbal body through the connecting structure 110, and two opposite sides of the lid 102 are further provided with second dodging slots 1023. The first magnetic attraction assembly 200 is arranged in the first accommodating slot 1011. Each of the clamping assemblies 300 includes a clamping arm 302, the two clamping assemblies 300 are respectively arranged on the two opposite sides of the housing 100, one end of each of the clamping assemblies 300 runs through the second dodging slot 1023 to expose the clamping arm 302, the clamping assemblies 300 are slidably connected to the housing 100, and a clamping region of the clamping arms 302 and a magnetic attraction region of the first magnetic attraction assembly 200 are respectively arranged on the two opposite sides of the housing 100.

The housing 100 includes the box 101 and the lid 102, the side of the box 101 away from the lid 102 is provided with the first accommodating slot 1011, and the first magnetic attraction assembly 200 is accommodated in the first accommodating slot 1011, thereby realizing the magnetic attraction function of the connecting device 1000. The clamping assemblies 300 arranged on the two opposite sides of the housing 100 include the clamping arms 302 such that the clamping assemblies 300 can clamp the electronic apparatus placed on the connecting device 1000 through the clamping arms 302. Thus, the connecting device 1000 can be connected to the electronic apparatus by two different methods, thereby improving the flexibility and applicability of the connecting device 1000. With the two connecting methods based on the first magnetic attraction assembly 200 and the clamping assemblies 300, the electronic apparatus on the connecting device 1000 can be fixed firmly, thereby preventing the electronic apparatus on the connecting device 1000 from shaking or falling off during use, and protecting the safety of the electronic apparatus. During actual use, the clamping assemblies 300 are slidable relative to the housing 100, so the clamping arms 302 can clamp the electronic apparatus on the connecting device by stretching the clamping assemblies 300. The magnetic attraction member 202 is arranged in the first accommodating slot 1011 on the side of the box 101 away from the lid 102, and the clamping arms 302 are arranged on the side of the connecting block 3011 facing the lid 102, so the connecting device 1000 can be connected to the electronic apparatus by different connecting methods by adjusting the direction during use. In addition, by arranging the connecting structure 110 on the housing 100, the two opposite sides of the housing 100 are both connectable to the gimbal body through the connecting structure 110, so when one side of the connecting device 1000 is connected to the electronic apparatus, the other side of the connecting structure 110 away from the electronic apparatus can be connected to the gimbal body. With the above arrangement, the connecting device 1000 is more convenient and flexible to operate, and the user can conveniently select and adjust the clamping method of the connecting device 1000 to meet the demands for different scenarios and uses.

Specifically, the housing 100 of the connecting device 1000 is formed by the box 101 and the lid 102, so that the connecting device 1000 is easier to assemble and disassemble. With the connecting structure 110 arranged on the housing 100, the two opposite sides of the housing 100 can both be used for quickly mounting and positioning expansion apparatuses such as the gimbal body, thereby improving the operating efficiency. With the second dodging slots 1023 of the box 101, the elastic retractable modules 301 can slide relative to the housing 100 and run through the second dodging slots 1023 to be connected to the clamping arms 302.

Referring to FIG. 6, the connecting structure 110 includes positioning slots 1021 provided on the two opposite sides of the lid 102, the box 101 is provided with a first dodging slot 1012 corresponding to one of the positioning slots 1021, and the first dodging slot 1012 is configured to expose the positioning slot 1021 such that the connecting structure 110 is fastened with a fastening portion of the gimbal body through the positioning slot 1021.

The two opposite sides of the lid 102 are respectively provided with the positioning slots 1021, and the box 101 is provided with the first dodging slot 1012 configured to expose one of the positioning slots 1021. The two opposite sides of the lid 102 are provided with the positioning slots 1021, and one of the positioning slots 1021 is exposed through the first dodging slot 1012 provided in the box 101, so that the gimbal body can be snap-fitted to the positioning slot 1021. By providing the positioning slots 1021 respectively on the two opposite sides of the lid 102, when one side of the connecting device 1000 is connected to the electronic apparatus, the side of the connecting structure 110 away from the side provided with the electronic apparatus can be connected to the gimbal body through the positioning slot 1021.

It should be noted that in this example, the fastening portion of the gimbal body is a fixed seat, and the connecting structure is clamped and connected with the positioning slot 1021 through the fixed seat.

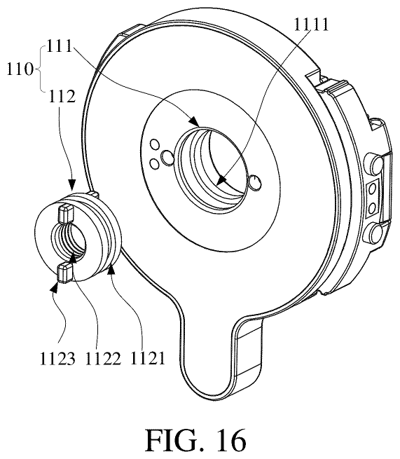

In an optional example of the disclosure, referring to FIG. 16, the connecting structure 110 includes a connecting hole 111 running through the housing 100, and a rotary ring 112 arranged in the connecting hole 111, an inner wall of the connecting hole 111 is provided with a sliding rail 1111, an outer ring of the rotary ring 112 is provided with a sliding slot 1121 corresponding to the sliding rail 1111, the rotary ring 112 is rotatably connected to the connecting hole 111 through the sliding rail 1111 and the sliding slot 1121, an inner ring of the rotary ring 112 is provided with a threaded hole 1122, and two opposite sides of the rotary ring 112 are respectively provided with bumps 1123 such that the connecting structure 110 is threadedly connected to a threaded rod of the gimbal body through the threaded hole 1122.

The housing 100 is provided with the connecting hole 111 running through the whole housing 100, the inner wall of the connecting hole 111 is provided with the sliding rail 1111, and the sliding rail 1111 is configured to be correspondingly slidably connected to the sliding slot 1121 of the rotary ring 112 arranged in the connecting hole 111, so that the rotary ring 112 can rotate relative to the connecting hole 111. The two opposite sides of the rotary ring 112 are respectively provided with the plurality of bumps 1123, and the bumps 1123 are configured to conveniently control the rotary ring 112 to rotate relative to the connecting hole 111, such that the threaded hole 1122 in the rotary ring 112 can be threadedly connected relative to the threaded rod of gimbal body. During actual use, the gimbal 2000 body is connected to one side of the connecting apparatus 1000, then the bumps 1123 on the other side are rotated to control the rotary ring 112 to rotate relative to the connecting hole 111, so that the threaded hole 1122 can be threadedly connected and locked to the threaded rod on the gimbal body, which avoids shaking and loosening during use, thereby ensuring a more stable and firmer connection relationship between the gimbal body and the connecting device 1000.

Specifically, the rotary ring 112 is controlled to rotate relative to the connecting hole 111 through the bumps 1123, so that the tightness between the gimbal 2000 body and the connecting device 1000 can be adjusted. The user can adjust the tightness of connection freely, so that the user can use the connecting device 1000 conveniently, which improves the flexibility of the connecting device 1000.

It should be noted that in this example, there are two bumps 1123 arranged at each end of the rotary ring 112, and there are four bumps 1123 arranged on the whole rotary ring 112. The two bumps 1123 located at one end are respectively arranged on two opposite sides of the threaded hole 1122.

In this example, the gimbal body is connected to the threaded hole 1122 of the connecting structure 110 through the threaded rod arranged on the gimbal body.

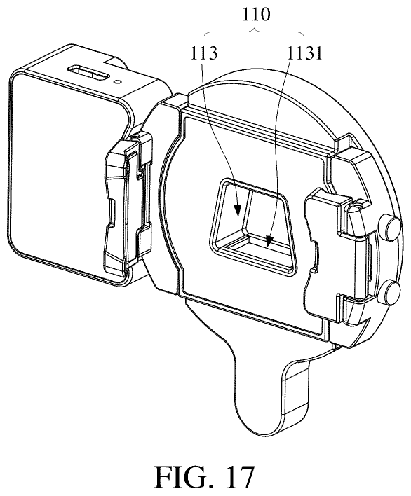

In an optional example of the disclosure, referring to FIG. 17, the connecting structure 110 includes a through slot 113 running through the housing 1000, and inner walls on two opposite sides of the through slot are respectively provided with a limit slot 1131 such that the connecting structure 110 is fastened with a fastening portion of the gimbal body through the limit slots 1131.

The housing 100 is provided with the through slot 113 running through the whole housing 100, and the through slot 113 is mainly configured to be connected to the external gimbal body. The inner walls on the two opposite sides of the through slot 113 are respectively provided with the limit slot 1131 which cooperatively abuts against and position the corresponding fastening portion on the gimbal body, so that the gimbal body and the connecting device 1000 can be positioned and limited with each other. During actual use, one side surface of the connecting device 1000 needs to clamp or be connected to the electronic apparatus. Since the through slot 113 runs through the whole housing 100, at one side surface of the housing 100 away from the electronic apparatus, the connecting device 1000 can be connected to the gimbal body through the through slot 113. Moreover, the limit slots 1131 can also cooperate with the fastening portion on the gimbal body, so that the gimbal body and the connecting device 1000 can be connected more stably and firmly, thereby avoiding loosening and shaking.

It should be noted that in this example, an outer contour of the through slot 113 is a trapezoidal structure. Therefore, accordingly, an outer contour of the fastening portion of the gimbal body is also a trapezoidal structure.

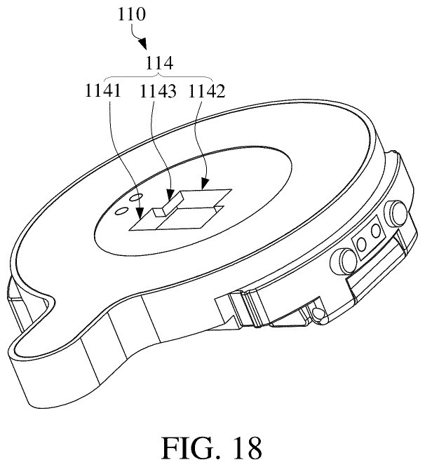

In an optional example of the disclosure, referring to FIG. 18, the connecting structure 110 includes boot openings 114 respectively provided on the two opposite sides of the housing 100. Each of the boot openings 114 includes a connecting slot 1141 and a snap-fit slot 1142 in communication with each other, two opposite sides of the snap-fit slot 1142 are provided with limit plates 1143, and the limit plates 1143 are arranged at a top of the snap-fit slot 1142 such that the connecting structure 110 is fastened with a fastening portion of the gimbal body through the limit plates 1143.

The two opposite sides of the housing 100 are provided with the boot openings 114, each of the boot openings 114 includes the connecting slot 1141 and the snap-fit slot 1142 connected with each other, the connecting slot 1141 is configured to be connected to the gimbal body, and the limit plates 1143 are arranged at the top of the snap-fit slot 1142, so the snap-fit slot 1142 can limit and position the gimbal body through the limit plates 1143. The limit plates 1143 can cooperatively abut against and limit the corresponding fastening portion on the gimbal body, so that the gimbal body and the connecting device 1000 can be locked and limited with each other. During actual use, one side surface of the connecting device 1000 needs to clamp or be connected to the electronic apparatus. Since the two opposite sides of the housing 100 are both provided with the boot openings 114, at one side surface of the housing 100 away from the electronic apparatus, the connecting device 1000 can be connected to the gimbal body through the boot opening 114. First, the gimbal body is allowed to correspond to the connecting slot 1141, and then the user allows the fastening portion of the gimbal body to slide into the snap-fit slot 1142 from the connecting slot 1141 by making adjustments, so that the limit plates 1143 arranged on the snap-fit slot 1142 can lock and limit the gimbal body, thereby realizing a firm connection between the gimbal body and the connecting device 1000.

In this example, the gimbal body is clamped and connected with the limit plates 1143 through the fastening portion, the fastening portion slides into the snap-fit slot 1142 through the connecting slot 1141, and the snap-fit slot 1142 limits the fastening portion through the limit plates 1143 arranged on the two opposite sides.

Referring to FIG. 1 to FIG. 4, each of the clamping assemblies 300 further includes an elastic retractable module 301, the elastic retractable module 301 runs through the second dodging slot 1023 and is rotatably connected to the clamping arm 302, the clamping arm 302 is rotatable by a preset angle relative to the elastic retractable module 301 such that the clamping arm 302 has a first state of being folded and a second state of being unfolded relative to the elastic retractable module 301, and the clamping arm 302 in the second state extends toward a side away from the first magnetic attraction assembly 200.

During actual use, the elastic retractable module 301 is retractable and elastically deformable relative to the housing 100, so after the elastic retractable module 301 is stretched, the clamping arm 302 connected on the elastic retractable module 301 has clamping force due to the elastic force of the elastic retractable module 301. As a result, the clamping arms 302 can tightly clamp the electronic apparatus clamped by the clamping assemblies 300, which ensures a stable and firm connection between the electronic apparatus and the connecting device 1000.

It should be noted that there is a certain preset angle between the elastic retractable module 301 and the clamping arm 302, and the preset angle is 0° to 90°. Therefore, when the preset angle is 0°, i.e., when the clamping arm 302 is completely attached to the elastic retractable module 301, the clamping arm 302 is in the first state of being folded. The first state is the storage state of the clamping arm 302. When the clamping arm 302 starts to rotate relative to the elastic retractable module 301 until it rotates to 90°, the clamping arm 302 is in the second state of being unfolded. The second state is the clamping state of the clamping arm 302.

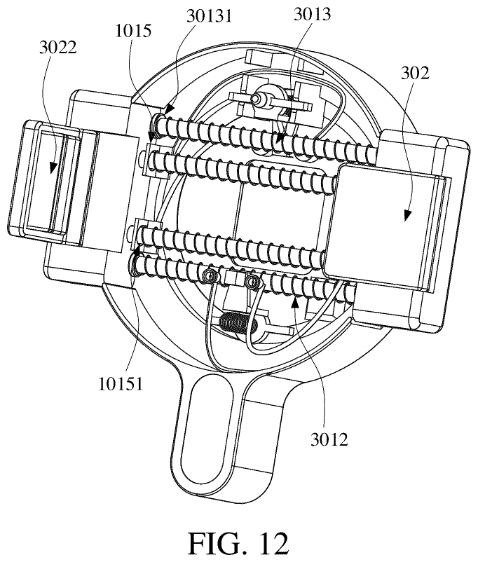

Referring to FIG. 3 and FIG. 12, the elastic retractable module 301 includes connecting rods 3013, first elastic members 3012 and a connecting block 3011, a side of the box 101 facing the lid 102 and a side of the lid 102 facing the box 101 are respectively connected with a connecting member 1015, the connecting member 1015 is provided with a via hole 10151, the connecting rod 3013 is slidably connected to the via hole 10151, the connecting rod 3013 runs through the second dodging slot 1023 and is connected to the connecting block 3011, the clamping arm 302 is rotatably connected to the connecting block 3011, an end of the connecting rod 3013 away from the connecting block 3011 is provided with a limit cap 30131, one end of the first elastic member 3012 abuts against the limit cap 30131, and the other end abuts against an edge of the via hole 10151.

The connecting member 1015 is configured to connect the connecting rod 3013 to the box 101 or the lid 102, and the connecting rod 3013 is also slidably connected to the via hole 10151 provided in the connecting member 1015, so that the user can control the clamping arms 302 to stably clamp the electronic apparatus through the connecting rods 3013. The end of the connecting rod 3013 away from the connecting block 3011 is provided with the limit cap 30131, and the two ends of the first elastic member 3012 respectively abut against the limit cap 30131 and the edge of the via hole 10151 of the connecting member 1015. During actual use, the connecting rod 3013 moves relative to the via hole 10151, so that the limit cap 30131 moves relative to the connecting member 1015. Thereby, the first elastic member 3012 arranged on the connecting rod 3013 is squeezed to produce elastic deformation, so that the two connecting rods 3013 arranged opposite to each other, and the connecting blocks 3011 and the clamping arms 302 connected on the connecting rods 3013 have clamping force for the electronic apparatus, thereby ensuring the stability and firmness of the electronic apparatus on the connecting device 1000.

Specifically, the connecting rod 3013 is slidably connected to the connecting member 1015 through the via hole 10151 in the connecting member 1015, which can make the structure of the connecting device 1000 firm, ensure the flexibility of the connecting rods 3013 as well as the connecting blocks 3011 and the clamping arms 302 connected by the connecting rods 3013, reduce the possibility of loosening and shaking between the connecting rods 3013 and the housing 100 and improve the reliability and stability of the connecting device 1000.

Specifically, the end of the connecting rod 3013 away from the connecting block 3011 is provided with the limit cap 30131, and the two ends of the first elastic member 3012 respectively abut against the limit cap 30131 and the edge of the via hole 10151. With the above arrangement, the elastic force can be provided to drive the connecting rods 3013 to move during the movement of the connecting rods 3013, thereby providing the clamping force for the electronic apparatus to the clamping arms 302 connected by the connecting rods 3013. Moreover, the connecting rods 3013 can move smoothly relative to the connecting members 1015, so that the connecting device 1000 can move more smoothly and stably.

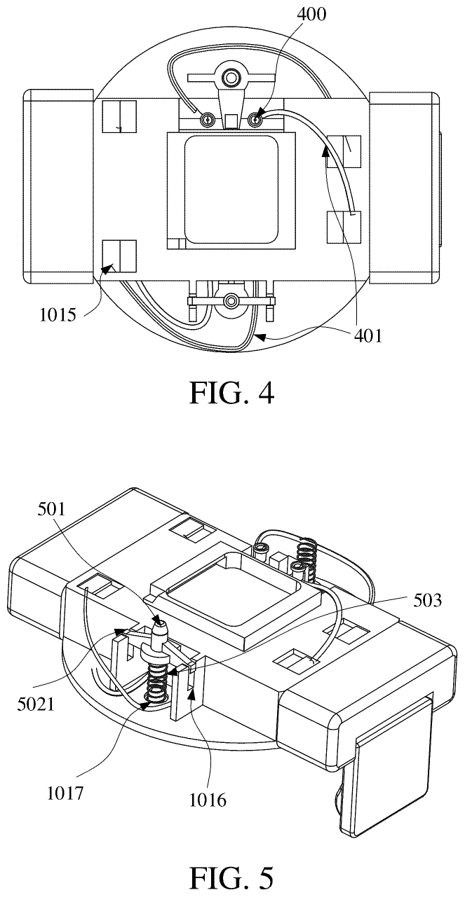

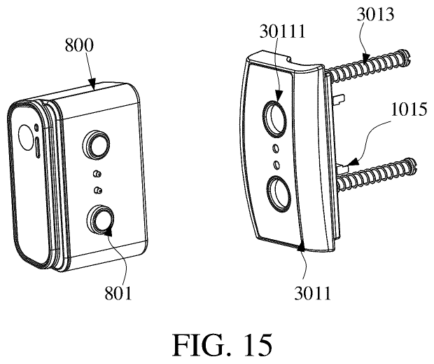

In an optional example of the disclosure, as shown in FIG. 3, FIG. 4 and FIG. 15, the connecting device 1000 further includes conductive seats 400, the conductive seats 400 are arranged on the box 101 and the lid 102 respectively, the box 101 and the lid 102 are respectively provided with a first dodging hole 1014, the conductive seats 400 are exposed through the first dodging holes 1014, and the conductive seats 400 are configured to be electrically connected to the gimbal body. The connecting device 1000 further includes an external module 800, the external module 800 is arranged on a side of the connecting block 3011 away from the connecting rod 3013, the conductive seats 400 are electrically connected to the connecting members 1015 and/or the connecting rods 3013 through connecting lines 401, the connecting block 3011 is provided with conductive sockets 30111, the external module 800 is provided with conductive posts 801 arranged corresponding to the conductive sockets 30111, and the conductive posts 801 are electrically connected to the conductive sockets 30111.

The conductive seats 400 are electrically connected to the connecting members 1015 such that the connecting device 1000 can be electrically connected to the external module 800, thereby improving the functionality and expansibility of the connecting device 1000. Moreover, the user can use the external module 800 connected to the connecting device 1000 conveniently. The conductive seats 400 are electrically connected to the connecting members 1015 through the connecting lines 401, which can ensure a reliable connection of the circuit and effective transmission of electrical signals or electrical energy, thereby improving the stability and performance of the connecting device 1000.

Specifically, the conductive seats 400 are configured to be electrically connected to the gimbal body externally connected to the connecting device 1000. The box 101 and the lid 102 are respectively provided with the first dodging hole 1014, and the conductive seats 400 are exposed through the first dodging holes 1014, which facilitates the electrical connection to the external gimbal body. The exposed conductive seats 400 are clearly visible, which is convenient to use and can avoid the possibility of misoperation.

On the other hand, the conductive seats 400 are electrically connected to the connecting members 1015 through the connecting lines 401, so that the connecting device 1000 can be electrically connected to the external module 800. In this way, the connecting device 1000 is more intelligent and multifunctional.

It should be noted that the external module 800 may be a fill light or an audio device.

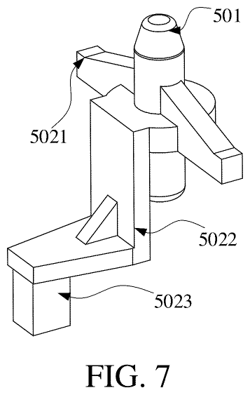

Referring to FIG. 3, FIG. 5, FIG. 6 and FIG. 7, the connecting device 1000 further includes a plurality of trigger keys 500 and second elastic members 503. Each of the trigger keys 500 includes an abutting post 501 and snap-fit protrusions 5021 arranged on two opposite sides of the abutting post 501. The lid 102 or the box 101 are provided with first sliding slots 1016 and positioning posts 1017. The snap-fit protrusion 5021 is slidably connected to the first sliding slot 1016. The box 101 and the lid 102 are respectively provided with a second dodging hole 1025. The two abutting posts 501 are respectively exposed through the second dodging hole 1025 in the lid 102 and the second dodging hole 1025 in the box 101. One end of the second elastic member 503 is sleeved on the positioning post 1017, and the other end abuts against the trigger key 500.

The trigger key 500 is slidably connected to the first sliding slot 1016 provided in the lid 102 or the box 101. Thus, when the connecting device 1000 is connected to an external expansion apparatus such as the gimbal body, the abutting post 501 can be squeezed after the gimbal body is connected to the connecting device 1000, so that the abutting post 501 can slide relative to the lid 102 or the box 101 so as to press the corresponding electric switch on the gimbal body on the other side. Thereby, the electric switch of the gimbal body is turned on, which helps the connecting device 1000 be electrically connected to the gimbal body, thereby improving the functionality of the connecting device 1000. During actual use, the abutting post 501 can slide relative to the second dodging hole 1025, so that the second elastic member 503 is squeezed to produce elastic force. As the second elastic member 503 needs to recover from its elastic deformation, the elastic force is converted into abutting force provided by the trigger key 500, so that the abutting post 501 is continuously stopped from returning to its original position by the electronic apparatus. Thereby, the other side of the trigger key 500 can continuously press the electric switch of the external gimbal body, so that the gimbal body can be electrically connected to the connecting device 1000 stably. Moreover, through the sliding in the first sliding slot 1016 and the elastic force of the second elastic member 503, the trigger key 500 is prevented from damaging the electronic apparatus and the gimbal body. With the above arrangement, the electrical connection between the connecting device 1000 and the external gimbal body is more visible and convenient, thereby improving the user experience.

Specifically, the lid 102 or the box 101 are provided with the positioning posts 1017, and one end of the second elastic member 503 is sleeved on the positioning post 1017, which can realize accurate positioning between the second elastic member 503 and the trigger key 500, thereby improving the operating accuracy and efficiency.

Specifically, one end of the second elastic member 503 is sleeved on the positioning post 1017 arranged on the box 101 or the lid 102, and the other end abuts against the trigger key 500, which can provide an additional support for the trigger key 500 and make the trigger key 500 move more stably and smoothly.

The two opposite sides of the abutting post 501 are respectively provided with the snap-fit protrusion 5021, and the snap-fit protrusion 5021 is slidably connected to the first sliding slot 1016, thereby ensuring the smooth slidable connection between the trigger key 500 and the first sliding slot 1016. The cooperation between the snap-fit protrusions 5021 and the first sliding slots 1016 can improve the firmness and stability of the connection, thereby preventing the abutting post 501 from falling off or loosening during the movement and improving the safety and reliability of the trigger key 500 during the sliding relative to the first sliding slots 1016.

Specifically, the second elastic member 503 is sleeved on the positioning post 1017 and abuts against the trigger key 500, so that the second elastic member 503 can be firmly and stably connected to the trigger key 500 and elastically support the abutting post 501.

Referring to FIG. 6 and FIG. 7, the trigger key 500 is further provided with an extension rod 5022, the extension rod 5022 extends toward a side away from the abutting post 501, an end portion of the extension rod 5022 has an abutting block 5023, the abutting block 5023 is arranged in an opposite direction to the abutting post 501, the box 101 and the lid 102 are respectively provided with a third dodging hole 1018 corresponding to the abutting block 5023, the abutting block 5023 is exposed through the third dodging holes 1018, and the abutting post 501 is configured to abut against the electronic apparatus.

The extension rod 5022 increases the length of the trigger key 500, so that the abutting post 501 on one side can abut against the electronic apparatus through the second dodging hole 1025 in either the box 101 or the lid 102, and the abutting block 5023 on the other side can be exposed after running through the third dodging hole 1018 on the other of the box 101 and the lid 102 and abut against the electric switch of the external gimbal body. Therefore, the extension rod 5022 is needed to meet the distance requirement between the lid 102 and the box 101.

During actual use, since one side surface of the connecting device 1000 needs to be magnetically connected to or to clamp the electronic apparatus and the other side surface needs to be connected to the gimbal body, when one side surface of the connecting device 1000 is connected to the electronic apparatus, the electronic apparatus squeezes the abutting post 501, so that the trigger key 500 slides relative to the housing 100. Thereby, the abutting block 5023 connected by this abutting post 501 can be exposed on the other side of the connecting device 1000, so that this abutting block 5023 can abut against the electric switch on the gimbal body, thereby triggering the electric switch of the gimbal body and facilitating the electrical connection between the gimbal body and the connecting device 1000.

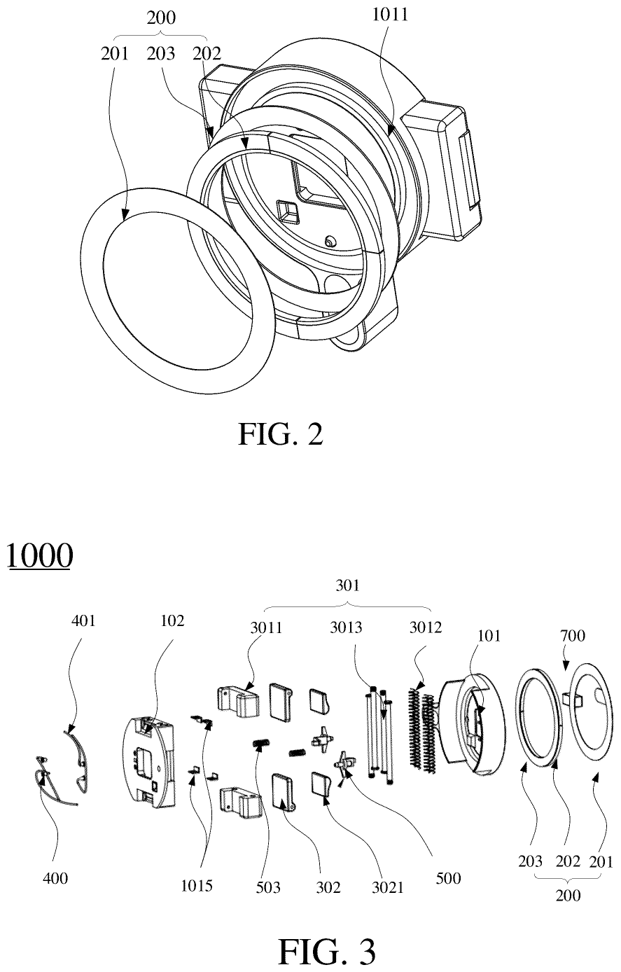

Referring to FIG. 1 and FIG. 2, the first magnetic attraction assembly 200 includes a protecting pad 201, an iron sheet 203 and one or a plurality of magnetic attraction members 202 arranged between the protecting pad 201 and the iron sheet 203, the iron sheet 203 is closely attached to a bottom of the first accommodating slot 1011, the protecting pad 201 is exposed through the first accommodating slot 1011, when there is one magnetic attraction member 202, the magnetic attraction member 202 is in a shape of a circular ring or a square, and when there are a plurality of magnetic attraction members 202, the magnetic attraction members 202 are respectively in a shape of an arc or a square.

The magnetic attraction member 202 is arranged between the iron sheet 203 and the protecting pad 201. That is, the iron sheet 203 is arranged in the first accommodating slot 1011, the magnetic attraction member 202 is arranged on a side of the iron sheet 203 away from the first accommodating slot 1011, and then the protecting pad 201 is arranged from the other side of the magnetic attraction member 202. The protecting pad 201 is configured to protect the electronic apparatus from being affected and scratched by the magnetic attraction member 202 when the first magnetic attraction assembly 200 is connected to the electronic apparatus. The iron sheet 203 is configured to adsorb the magnetic attraction member 202 and help the magnetic attraction member 202 placed in the first accommodating slot 101. Moreover, the iron sheet 203 can enhance the magnetic attraction force of the magnetic attraction member 202.

On the other hand, there may be one or a plurality of magnetic attraction members 202 arranged. When there is one magnetic attraction member 202 arranged, the magnetic attraction member 202 is a whole, so the magnetic attraction member 202 is in the shape of a circular ring or a square. When there are a plurality of magnetic attraction members 202, it indicates that the first magnetic attraction assembly 200 is formed by the plurality of magnetic attraction members 202, and in this case, the magnetic attraction members 202 are respectively in the shape of an arc or a square.

It should be noted that there are a plurality of magnetic attraction members 202 in the first magnetic attraction assembly 200, the magnetic attraction members 202 are sequentially arranged with the N pole of one magnetic attraction member corresponding to the S pole of the next magnetic attraction member to fill the whole first accommodating slot 1011.

Referring to FIG. 14, the connecting device 1000 further includes a second magnetic attraction assembly 700, the box 101 further extends to form an extension portion 1022, the extension portion 1022 is provided with a second accommodating slot 10221, the second magnetic attraction assembly 700 is arranged in the second accommodating slot 10221, the second accommodating slot 10221 is provided in a same direction as the first accommodating slot 1011, and the second accommodating slot 10221 is provided on a side of a circumference of the first accommodating slot 1011.

The second magnetic attraction assembly 700 is arranged in the extension portion 1022 of the box 101, the extension portion 1022 is provided with the second accommodating slot 10221, the second magnetic attraction assembly 700 is accommodated in the second accommodating slot 10221, and the second magnetic attraction assembly 700 is arranged in the same direction as the first magnetic attraction assembly 200, so the second magnetic attraction assembly 700 can cooperate with the magnetic connection of the first magnetic attraction assembly 200 and assist in positioning and connecting the magnetically attracted electronic apparatus.

Referring to FIG. 12 and FIG. 13, a side surface of the clamping arm 302 facing the connecting block 3011 is provided with a recess 3021, each of the clamping assemblies 300 further includes a protective pad 3022, the protective pad 3022 is arranged in the recess 3021, and the lid 102 is provided with third dodging slots 1024 for dodging the clamping arm 302 and the protective pad 3022.

The protective pads 3022 are configured to protect the contact surface of the electronic apparatus and the clamping arms 302 when the clamping arms 302 clamp the electronic apparatus. The protective pads 3022 can reduce friction with the clamped object. The protective pads 3022 are made of silicone. Silicone is soft and wear-resistant, so it can reduce damage to the clamped object and protect the surface of the electronic apparatus from being scratched or worn during the clamping process, thereby preventing the clamping arms 302 from directly acting on the electronic apparatus and avoiding affecting and damaging the electronic apparatus. The recess 3021 provided on the side of the clamping arm 302 facing the connecting block 3011 can increase the connection area between the protective pad 3022 and the clamping arm 302, thereby ensuring the stability and firmness of connection of the protective pad 3022 on the clamping arm 302, and preventing the protective pad 3022 from coming off easily during use.

Specifically, in addition to protecting the electronic apparatus, the protective pads 3022 can also reduce the damage of external collision or friction on the clamping arms 302, thereby prolonging the service life of the clamping arms 302 and improving the durability of the clamping assemblies 300.

Specifically, the lid 102 is provided with the third dodging slots 1024 for dodging the clamping arms 302 and the protective pads 3022. In this way, the clamping arm 302 in the first state can be better attached to the connecting block 3011, so that the connecting device 1000 can occupy a smaller space, which is convenient to carry and store the connecting device 1000.

An example of the disclosure further provides a gimbal 2000. The gimbal 2000 includes a grip 2001, a gimbal body 600 and a connecting device 1000. The gimbal body 600 is rotatably connected to the connecting device 1000.

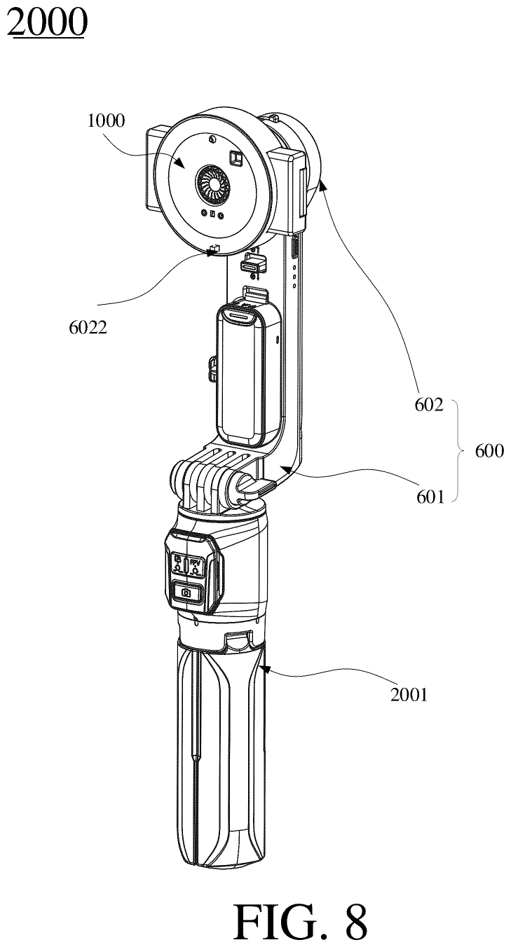

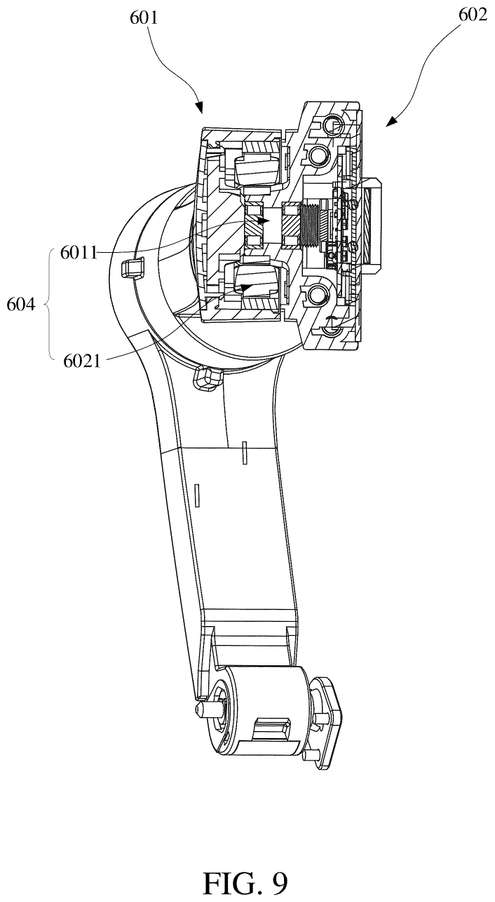

Further, referring to FIG. 8 to FIG. 10, the gimbal body 600 includes a connecting arm 601 and a rotating module 602 that are rotatably connected, a rotating motor 604 is arranged between the connecting arm 601 and the rotating module 602, the rotating module 602 is rotatably connected to the connecting arm 601 through the rotating motor 604, and the connecting device 1000 is connected to a side of the rotating module 602 away from the connecting arm 601.

The rotating motor 604 is arranged between the connecting arm 601 and the rotating module 602, the rotating motor 604 includes a rotor 6011 and a stator 6021, the stator 6021 is arranged in the rotating module 602, the rotor 6011 is arranged in the connecting arm 601, and the rotor 6011 is rotatably connected to the stator 6021 in the rotating module 602 so as to realize the rotatable connection between the rotating module 602 and the connecting arm 601. Therefore, after the connecting device 1000 is connected to the rotating module 602, both the connecting device 1000 and the electronic apparatus arranged on the connecting device 1000 can rotate relative to the connecting arm 601 through the rotating module 602, thereby improving the operability and the movement range of the gimbal 2000. The rotatable connection with the connecting device 1000 through the motor assembly can realize a firm connection. The rotating motor 604 formed by the rotor 6011 and the stator 6021 can provide rotating power, which makes the rotation of the connecting device 1000 more stable and controllable, and improves the stability of the movement of the gimbal 2000.

Referring to FIG. 1, FIG. 6, FIG. 13 and FIG. 14, the connecting device 1000 includes: a housing 100, a first magnetic attraction assembly 200 and two clamping assemblies 300. The housing 100 includes a box 101 and a lid 102 that are buckled with each other, the box 101 is provided with a first accommodating slot 1011, two opposite sides of the housing 100 are respectively provided with a connecting structure 110, the connecting structure 110 is configured to be connected to the gimbal body, and two opposite sides of the lid 102 are further provided with second dodging slots 1023. The first magnetic attraction assembly 200 is arranged in the first accommodating slot 1011. Each of the clamping assemblies 300 includes a clamping arm 302, the two clamping assemblies 300 are respectively arranged on the two opposite sides of the housing 100, one end of each of the clamping assemblies 300 runs through the second dodging slot 1023 to expose the clamping arm 302, the clamping assemblies 300 are slidably connected to the housing 100, and a clamping region of the clamping arms 302 and a magnetic attraction region of the first magnetic attraction assembly 200 are respectively arranged on the two opposite sides of the housing 100.

The housing 100 includes the box 101 and the lid 102, the side of the box 101 away from the lid 102 is provided with the first accommodating slot 1011, and the first magnetic attraction assembly 200 is accommodated in the first accommodating slot 1011, thereby realizing the magnetic attraction function of the connecting device 1000. The clamping assemblies 300 arranged on the two opposite sides of the housing 100 include the clamping arms 302 such that the clamping assemblies 300 can clamp the electronic apparatus placed on the connecting device 1000 through the clamping arms 302. Thus, the connecting device 1000 can be connected to the electronic apparatus by two different methods, thereby improving the flexibility and applicability of the connecting device 1000. With the two connecting structures based on the first magnetic attraction assembly 200 and the clamping assemblies 300, the electronic apparatus on the connecting device 1000 can be fixed firmly, thereby preventing the electronic apparatus on the connecting device 1000 from shaking or falling off during use, and protecting the safety of the electronic apparatus. During actual use, the clamping assemblies 300 are slidable relative to the housing 100, so the clamping arms 302 can clamp the electronic apparatus on the connecting device by stretching the clamping assemblies 300. The magnetic attraction member 202 is arranged in the first accommodating slot 1011 on the side of the box 101 away from the lid 102, and the clamping arms 302 are arranged on the side of the connecting block 3011 facing the lid 102, so the connecting device 1000 can be connected to the electronic apparatus by different connecting methods by adjusting the direction during use. In addition, by arranging the connecting structure 110 respectively on the two opposite sides of the housing 100, when one side of the connecting device 1000 is connected to the electronic apparatus, the connecting structure 110 away from the electronic apparatus can be connected to the gimbal body.

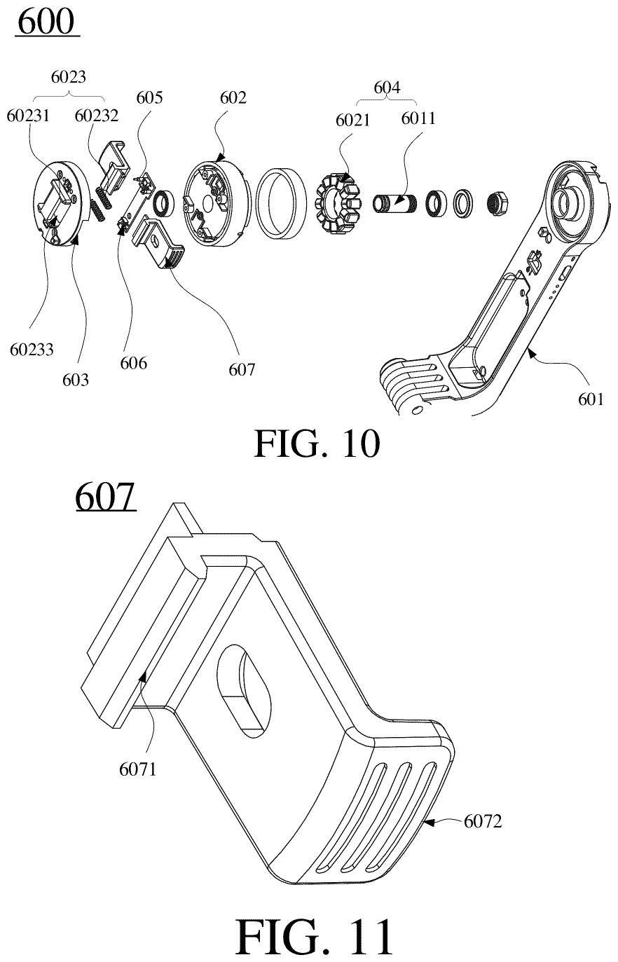

Referring to FIG. 10 and FIG. 11, a side of the rotating module 602 facing the connecting device 1000 is further provided with a locking assembly 6023, the locking assembly 6023 includes a fixed seat 60231, a third elastic member 60232 and two locking buckles 607, two opposite sides of the fixed seat 60231 are provided with second sliding slots 60233, the locking buckle 607 is slidably connected to the second sliding slot 60233, each of the locking buckles 607 includes a locking portion 6071 and a manual adjusting portion 6072, the third elastic member 60232 is arranged between the two locking portions 6071, two opposite sides of the rotating module 602 are provided with fourth dodging slots 603, the manual adjusting portion 6072 is exposed after running through the fourth dodging slot 603, two opposite sides of an inner wall of a positioning slot 1021 of the connecting device 1000 are respectively provided with a locking slot 10211, the fixed seat 60231 is correspondingly connected to the positioning slot 1021, and the locking portion 6071 is capable of being locked to or unlocked from the locking slot 10211.

The fixed seat 60231 is correspondingly connected to the positioning slot 1021, and the locking portion 6071 is correspondingly connected to the locking slot 10211, which can realize accurate positioning between the locking assembly 6023 on the rotating module 602, and the positioning slot 1021 and the locking slot 10211 in the connecting device 1000. The arrangement of the locking assembly 6023 ensures the rotating module 602 to be correctly aligned with the connecting device 1000 during mounting and improves the mounting accuracy and efficiency. Moreover, this improves the strength of connection between the connecting device 1000 and the rotating module 602, prevents the connecting device 1000 and the rotating module 602 from shaking and separation during use, and avoids affecting the use of the electronic apparatus. During actual use, the locking assembly 6023 corresponds to the whole positioning slot 1021, and then the manual adjusting portions 6072 arranged on the two opposite sides of the rotating module 602 are pressed by a hand such that the two locking portions 6071 can slide relative to the second sliding slots 60233 on the two opposite sides of the fixed seat 60231. Thereby, the fixed seat 60231 and the positioning slot 1021 can be positioned and fastened. Then, the manual adjusting portions 6072 are released. Due to the elastic force of the third elastic member 60232 between the two locking portions 6071, the two locking portions 6071 can slide relative to the second sliding slots 60233 so as to be positioned and fastened with the locking slots 10211 provided on the two opposite sides of the positioning slot 1021, thereby finally completing the stable connection between the connecting device 1000 and the rotating module 602.

Specifically, the third elastic member 60232 arranged can provide a certain elastic support for the two locking buckles 607 arranged oppositely, and function as an elastic support for the locking buckles 607 during the connection process. The manual adjusting portions 6072 exposed through the fourth dodging slots 603 are convenient for the user to control and operate manually. By manually controlling the relative movement between the two locking portions 6071, the connecting device 1000 can be conveniently connected to the rotating module 602.

Specifically, the locking buckles 607 can make the connection between the locking assembly 6023 and the connecting device 1000 more stable, and the locking portion 6071 is correspondingly connected to the locking slot 10211, which improves the strength of connection between the connecting device 1000 and the rotating module 602. Moreover, the movement of the locking portion 6071 on the second sliding slot 60233 is controlled by manually controlling the manual adjusting portions 6072, which makes the operation more convenient and faster and improves the operating convenience and efficiency.

Referring to FIG. 10 and FIG. 11, elastic contact pins 605 and an electric switch 606 are arranged in the rotating module 602, the elastic contact pins 605 and the electric switch 606 are respectively exposed after running through the rotating module 602, the elastic contact pins 605 are correspondingly connected to conductive seats 400 of the connecting device 1000, and the electric switch 606 correspondingly abuts against an abutting block 5023 of the connecting device 1000.

The elastic contact pins 605 are electrically connected to the conductive seats 400, thereby realizing the electrical connection between the gimbal body 600 and the connecting device 1000. The electrical connection between the elastic contact pins 605 and the conductive seats 400 ensures stable transmission of electrical signals between the gimbal body 600 and the connecting device 1000, thereby realizing the electrical control function of the connecting device 1000. The electric switch 606 correspondingly abuts against the abutting block 5023 on the trigger key 500. By making the abutting block 5023 abut against or leave the electric switch 606, the electric switch 606 of the gimbal body 600 is turned on or off, so that the user can automatically and conveniently control the electric switch 606 in the gimbal body 600 to be on or off, and there is no need to manually turn on the electric switch, thereby making the gimbal 2000 more convenient and flexible to operate.

Specifically, the electric switch 606 arranged on the gimbal body 600 can improve the safety of the electrical connection between the connecting device 1000 and the gimbal body 600. Through the connection between the abutting block 5023 and the electric switch 606, misoperation or accidental triggering can be effectively avoided, thereby improving the safety of the gimbal 2000 and reducing the risk of accidental injury.

Referring to FIG. 1 and FIG. 8, the box 101 and the lid 102 of the connecting device 1000 are respectively provided with a foolproof position 1019, a side of the rotating module 602 facing the connecting device 1000 is provided with positioning protrusions 6022, and the positioning protrusions 6022 are correspondingly connected to the foolproof positions 1019.

The corresponding connection between the foolproof positions 1019 and the positioning protrusions 6022 can ensure correct mounting between the connecting device 1000 and the gimbal body 600. With this arrangement, the connecting device 1000 can only be connected and mounted to the gimbal body 600 in the correct direction and position, and wrong mounting or reversed mounting can be prevented, thereby improving the accuracy and stability of mounting and combination between the connecting device 1000 and the gimbal body 600.

Specifically, the cooperation between the foolproof positions 1019 and the positioning protrusions 6022 can ensure the uniqueness of the connection between the gimbal body 600 and the connecting device 1000. Moreover, the foolproof positions 1019 can function to position and limit the positioning protrusions 6022, which can prevent the connecting device 1000 and the gimbal body 600 from moving or swinging unexpectedly after the completion of the assembly and keep the stability between the connecting device 1000 and the external structure, thereby avoiding unnecessary damage or faults.

Specifically, the arrangement of the foolproof positions 1019 and the positioning protrusions 6022 can facilitate the user's identification and help the user to quickly position and mount the connecting device 1000 and the gimbal body 600, which simplifies the mounting and connecting process and reduces the mounting difficulty and time cost.

In an optional example of the disclosure, the connecting arm 601 is a single steering knuckle or a plurality of steering knuckles rotatably connected sequentially.

Exemplarily, when the connecting arm 601 is a plurality of steering knuckles rotatably connected sequentially, there are 2 or 3 steering knuckles.

It should be noted that the single steering knuckle means that the connecting arm 601 cannot rotate or change its direction itself, and can only rotate through the possible rotatable connection relationship with the grip 2001. If the connecting arm 601 is a plurality of steering knuckles rotatably connected sequentially, the connecting arm 601 itself has at least one rotation direction, that is, the rotatably connected steering knuckles can rotate relative to each other.

An example of the disclosure further provides a gimbal 2000. The gimbal 2000 includes a grip 2001, a gimbal body 600 and the connecting device 1000 in the aforementioned examples. The gimbal body 600 is rotatably connected to the connecting device 1000.

The gimbal 2000 has the same structure and beneficial effects as the connecting device 1000 in the aforementioned examples. The structure and beneficial effects of the connecting device 1000 have been described in detail in the aforementioned examples and will not be repeated here.

It should be noted that the above examples are only used to illustrate the technical solutions of the disclosure and are not intended to limit the disclosure. Those skilled in the art can modify the technical solutions described in the above examples, or make equivalent substitutions to some technical features. All these modifications and substitutions shall fall into the protection scope of the appended claims of the disclosure.

What is claimed is:

1. A connecting device, comprising:
a housing, the housing comprising a box and a lid that are buckled with each other, the box being provided with a first accommodating slot, the housing being provided with a connecting structure such that two opposite sides of the housing are both connectable to a gimbal body through the connecting structure, and two opposite sides of the lid being further provided with second dodging slots;
a first magnetic attraction assembly, the first magnetic attraction assembly being arranged in the first accommodating slot; and
two clamping assemblies, each of the clamping assemblies comprising a clamping arm, the two clamping assemblies being respectively arranged on the two opposite sides of the housing, one end of each of the clamping assemblies running through the second dodging slot to expose the clamping arm, the clamping assemblies being slidably connected to the housing, the clamping arms being configured to clamp an electronic apparatus, and a clamping region of the clamping arms and a magnetic attraction region of the first magnetic attraction assembly being respectively arranged on the two opposite sides of the housing.

2. The connecting device according to claim 1, wherein the connecting structure comprises positioning slots provided on the two opposite sides of the lid, the box is provided with a first dodging slot corresponding to one of the positioning slots, and the first dodging slot is configured to expose the positioning slot such that the connecting structure is fastened with a fastening portion of the gimbal body through the positioning slot.

3. The connecting device according to claim 1, wherein the connecting structure comprises a connecting hole running through the housing, and a rotary ring arranged in the connecting hole, an inner wall of the connecting hole is provided with a sliding rail, an outer ring of the rotary ring is provided with a sliding slot corresponding to the sliding rail, the rotary ring is rotatably connected to the connecting hole through the sliding rail and the sliding slot, an inner ring of the rotary ring is provided with a threaded hole, and two opposite sides of the rotary ring are respectively provided with bumps such that the connecting structure is threadedly connected to a threaded rod of the gimbal body through the rotary ring.

4. The connecting device according to claim 1, wherein the connecting structure comprises a through slot running through the housing, and inner walls on two opposite sides of the through slot are respectively provided with a limit slot such that the connecting structure is fastened with a fastening portion of the gimbal body through the limit slots.

5. The connecting device according to claim 1, wherein the connecting structure comprises boot openings respectively provided on the two opposite sides of the housing, each of the boot openings comprises a connecting slot and a snap-fit slot in communication with each other, two opposite sides of the snap-fit slot are provided with limit plates, and the limit plates are arranged at a top of the snap-fit slot such that the connecting structure is fastened with a fastening portion of the gimbal body through the limit plates.

6. The connecting device according to claim 2, wherein each of the clamping assemblies further comprises an elastic retractable module, the elastic retractable module runs through the second dodging slot and is rotatably connected to the clamping arm, the clamping arm is rotatable by a preset angle relative to the elastic retractable module such that the clamping arm has a first state of being folded and a second state of being unfolded relative to the elastic retractable module, and the clamping arm in the second state extends toward a side away from the first magnetic attraction assembly.

7. The connecting device according to claim 6, wherein the elastic retractable module comprises connecting rods, first elastic members and a connecting block, a side of the box facing the lid and a side of the lid facing the box are respectively connected with a connecting member, the connecting member is provided with a via hole, the connecting rod is slidably connected to the via hole, the connecting rod runs through the second dodging slot and is connected to the connecting block, the clamping arm is rotatably connected to the connecting block, an end of the connecting rod away from the connecting block is provided with a limit cap, one end of the first elastic member abuts against the limit cap, and the other end abuts against an edge of the via hole.

8. The connecting device according to claim 7, wherein the connecting device further comprises conductive seats, the conductive seats are arranged on the box and the lid respectively, the box and the lid are respectively provided with a first dodging hole, the conductive seats are exposed through the first dodging holes, and the conductive seats are configured to be electrically connected to the gimbal body; and the connecting device further comprises an external module, the external module is arranged on a side of the connecting block away from the connecting rod, the conductive seats are electrically connected to the connecting members and/or the connecting rods through connecting lines, the connecting block is provided with conductive sockets, the external module is provided with conductive posts arranged corresponding to the conductive sockets, and the conductive posts are electrically connected to the conductive sockets.

9. The connecting device according to claim 1, wherein the connecting device further comprises a plurality of trigger keys and second elastic members, the trigger keys are slidably connected to the box or the lid, one end of each of the trigger keys is provided with an abutting post, the abutting post is exposed after running through the second dodging hole respectively provided in the box or the lid, the second elastic member is arranged between the trigger key and the lid or the box, each of the trigger keys further comprises an abutting block, the abutting block is arranged in an opposite direction to the abutting post, the box and the lid are respectively provided with a third dodging hole corresponding to the abutting block, the abutting block is exposed through the third dodging holes, and the abutting post is configured to abut against the electronic apparatus.

10. The connecting device according to claim 1, wherein the first magnetic attraction assembly comprises a protecting pad, an iron sheet and one or a plurality of magnetic attraction members arranged between the protecting pad and the iron sheet, the iron sheet is closely attached to a bottom of the first accommodating slot, the protecting pad is exposed through the first accommodating slot, when there is one magnetic attraction member, the magnetic attraction member is in a shape of a circular ring or a square, and when there are a plurality of magnetic attraction members, the magnetic attraction members are respectively in a shape of an arc or a square.

11. The connecting device according to claim 1, wherein the connecting device further comprises a second magnetic attraction assembly, the box further extends to form an extension portion, the extension portion is provided with a second accommodating slot, the second magnetic attraction assembly is arranged in the second accommodating slot, the second accommodating slot is provided in a same direction as the first accommodating slot, and the second accommodating slot is provided on a side of a circumference of the first accommodating slot.

12. A gimbal, comprising a grip, a gimbal body and a connecting device, wherein the gimbal body is rotatably connected to the connecting device; and
the gimbal body comprises a connecting arm and a rotating module that are rotatably connected, a rotating motor is arranged between the connecting arm and the rotating module, the rotating module is rotatably connected to the connecting arm through the rotating motor, and the connecting device is connected to a side of the rotating module away from the connecting arm.

13. The gimbal according to according to claim 12, wherein the connecting device comprises:
a housing, the housing comprising a box and a lid that are buckled with each other, the box being provided with a first accommodating slot, two opposite sides of the housing being respectively provided with a connecting structure, the connecting structure being configured to be connected to the gimbal body, and two opposite sides of the lid being further provided with second dodging slots;
a first magnetic attraction assembly, the first magnetic attraction assembly being arranged in the first accommodating slot; and
two clamping assemblies, each of the clamping assemblies comprising a clamping arm, the two clamping assemblies being respectively arranged on the two opposite sides of the housing, one end of each of the clamping assemblies running through the second dodging slot to expose the clamping arm, the clamping assemblies being slidably connected to the housing, the clamping arms being configured to clamp an electronic apparatus, and a clamping region of the clamping arms and a magnetic attraction region of the first magnetic attraction assembly being respectively arranged on the two opposite sides of the housing.

14. The gimbal according to claim 13, wherein a side of the rotating module facing the connecting device is further provided with a locking assembly, the locking assembly comprises a fixed seat, a third elastic member and two locking buckles, two opposite sides of the fixed seat are provided with second sliding slots, the locking buckle is slidably connected to the second sliding slot, each of the locking buckles comprises a locking portion and a manual adjusting portion, the third elastic member is arranged between the two locking portions, two opposite sides of the rotating module are provided with fourth dodging slots, the manual adjusting portion is exposed after running through the fourth dodging slot, two opposite sides of an inner wall of a positioning slot of the connecting device are respectively provided with a locking slot, the fixed seat is correspondingly connected to the positioning slot, and the locking portion is capable of being locked to or unlocked from the locking slot.

15. The gimbal according to claim 13, wherein elastic contact pins and an electric switch are arranged in the rotating module, the elastic contact pins and the electric switch are respectively exposed after running through the rotating module, the elastic contact pins are correspondingly connected to conductive seats of the connecting device, and the electric switch correspondingly abuts against an abutting block of the connecting device.

16. The gimbal according to claim 13, wherein the box and the lid of the connecting device are respectively provided with a foolproof position, a side of the rotating module facing the connecting device is provided with positioning protrusions, and the positioning protrusions are correspondingly connected to the foolproof positions.

17. The gimbal according to claim 13, wherein the connecting arm is a single steering knuckle or a plurality of steering knuckles connected sequentially.

18. A gimbal, comprising a grip, a gimbal body and the connecting device according to claim 1, wherein the gimbal body is rotatably connected to the connecting device.
